(19) United States
(12) Patent Application Publication
(10) Pub. No.: US 2023/0172244 A1
(43) Pub. Date: Jun. 8, 2023

(54) FLAVOR PARTICLE

(71) Applicant: Firmenich SA, Satigny (CH)

(72) Inventor: Jian ZHANG, Plainsboro, NJ (US)

(21) Appl. No.: 17/997,534

(22) PCT Filed: Apr. 29, 2021
(86) PCT No.: PCT/EP2021/061230

§ 371 Date: Oct. 28, 2022

Related U.S. Application Data
(60) Provisional application No. 63/017,945, filed on Apr. 30, 2020.

(30) Foreign Application Priority Data
May 8, 2020 (EP) 20173718.6

(51) Int. Cl. A23L 27/12; A23L 27/30; A23L 27/00

(52) U.S. Cl. CPC A23L 27/13; A23L 27/33; A23L 27/72

(57) ABSTRACT

The present invention relates to the field of flavoring. The present invention relates to a flavor particle comprising a flavor, allulose and a carrier, a flavored article comprising the same as well as processes of preparing the same and uses thereof.

### TECHNICAL FIELD

The present invention relates to the field of flavoring. The present invention relates to a flavor particle comprising a flavor, allulose and a carrier, a flavored article comprising the same as well as processes of preparing the same and uses thereof.

### BACKGROUND OF THE INVENTION

The consumer’s demand for flavor delivery systems is more and more important and is driving the development of new delivery systems.

Flavor delivery systems in form of particles are commonly used in the field of flavoring because they are easy to dose, handle and prepare.

One of the problems faced by the flavor industry, however, lies in the oxidation of active ingredients when in particular oxidizable flavors are encapsulated. This oxidation creates off-flavors or off-notes unpleasant for the consumer. Furthermore, this oxidation phenomenon leads to difficult prediction of the shelf life of the final product upon storage. For example, for citrus flavours, which are especially sensitive to oxygen, the shelf life of spray dried citrus flavor typically does not exceed 12 months. Indeed, it is known that limonene is present as the main compound in many citrus oils, especially orange oil. When exposed to oxygen, limonene reacts to yield epoxides, alcohols, and ketones which are responsible for the off-notes in the flavor oil. Limonene degrades to limonene oxide (also called limonene epoxides) which further degrades to carveol and carvone.

One further problem lies in the consumer’s demand for natural ingredients.

One further problem lies in the consumer’s demand for low-sugar or sugar-free delivery systems and ingredients. For example, the ever-increasing average weight of the world population and weight associated diseases associated with increased sugar consumption are considered a major problem for both single humans as well as the public health system.

One further problem lies in the storage stability of the flavor delivery system and/or retention of the flavor in the delivery system, in particular the storage stability and/or retention of the flavor in the delivery system before applying it to a food product or beverage. For example, it is desired that the flavor is retained in the delivery system before using it as long as possible or in other words that it does not leak out from the delivery system.

One further problem lies in the fast provision of the flavor from the flavor delivery system. For example, it is desired that the flavor in the delivery system is provided to a food product or beverage as fast as possible in order to reduce the time of preparing flavored products or beverages.

The present invention provides a solution to some and preferably all of the above-mentioned problems.

### DETAILED DESCRIPTION

The present invention relates to a flavor particle comprising
a flavor,
allulose and
a carrier,
optionally, an emulsifier, and
optionally, a sweetener.

In a particular embodiment, the flavor particle according to the present invention is an amorphous particle.

In a particular embodiment, the flavor particle has a glass transition temperature of equal to or greater than 25° C., preferably equal to or greater than 30° C. and more preferably equal to or greater than 40° C. In a particular embodiment, the flavor particle has a glass transition temperature of equal to or less than 120° C., preferably equal to or less than 100° C. and more preferably equal to or less than 90° C. In a particular embodiment, the flavor particle has a glass transition temperature greater than 25° C. and less than 120° C., preferably greater than 35° C. and less than 100° C. and more preferably 40° C. to 90° C. The glass transition temperature can be measured by standard methods known by a skilled person such as by using a differential scanning calorimeter Q2000 (TA Instruments, New Castle, DE, USA).

In a particular embodiment, the flavor particle is in a solid, granular state.

In a particular embodiment, the flavor particle is free-flowing.

In a particular embodiment, the flavor particle has an average particle size of equal to or greater than 30 µm and preferably equal to or greater than 50 µm. In a particular embodiment, the flavor particle as an average particle size of equal to or less than 5000 µm, preferably equal to or less than 2000 µm and more preferably equal to or less than 1000 µm. In a particular embodiment, the flavor particle has an average particle size of 30 to 5000 µm, preferably 50 to 2000 µm and more preferably 50 to 1000 µm. The average particle size can be measured by standard methods known by a skilled person such as by using Beckman Coulter Laser Diffraction Particle Size Analyzer (Coulter LS 13320) with Tornado Dry Powder Module (Beckman Coulter Inc., Miami, FL).

The flavor particle according to the present invention comprises a flavor.

By the term “flavor” it is herein understood a flavor or flavoring composition being a flavoring ingredient or a mixture of flavoring ingredients, solvents or adjuvants used for the preparation of a flavoring formulation, i.e. a particular mixture of ingredients which is intended to be added to a drinkable or edible composition (including but not limited to a beverage) or chewable product to impart, improve or modify its organoleptic properties, in particular its flavor and/or taste. Flavoring ingredients are well known to a person skilled in the art and their nature does not warrant a detailed description here, which in any case would not be exhaustive, the skilled flavorist being able to select them on the basis of his or her general knowledge and according to the intended use or application and the organoleptic effect it is desired to achieve.

In a particular embodiment, the flavor is suitable for use in food and/or beverages. In a particular embodiment, the flavor is suitable for use in food and beverages and wherein the flavor is susceptible to oxidation and/or acid degradation.

In a particular embodiment, the flavor has a log P value of 2 orgreater. The log P refers to the logarithm (log) of the partition coefficient (P) and defines a particular ratio of the concentrations of a solute between two solvents (a biphase of liquid phases), specifically for un-ionized solutes. A person skilled in the art is able to determine and measure the log P.

Typical flavors to be used for the flavor particle according to the present invention are flavors that are derived from or based on fruits where citric acid is the predominant, naturally-occurring acid include but are not limited to, for example, citrus fruits (e.g., lemon, lime), limonene, strawberry, orange, and pineapple. In one embodiment, the flavor is lemon, lime or orange juice extracted directly from the fruit. Further embodiments of the flavor comprise the juice or liquid extracted from oranges, lemons, grapefruits, limes, citrons, Clementines, mandarins, tangerines, and any other citrus fruit, or variation or hybrid thereof. In a particular embodiment, the flavor comprises a liquid extracted or distilled from oranges, lemons, grapefruits, limes, citrons, Clementines, mandarins, tangerines, any other citrus fruit or variation or hybrid thereof, pomegranates, kiwifruits, watermelons, apples, bananas, blueberries, melons, ginger, bell peppers, cucumbers, passion fruits, mangos, pears, tomatoes, and strawberries.

In a particularly preferred embodiment, the flavor is orange, lemon or lime.

In a further particular embodiment, the flavor comprises citral and/or limonene.

In a particular embodiment, the flavor particle comprises a flavor in an amount of equal to or greater than 1 wt.%, preferably equal to or greater than 5 wt.% and more preferably equal to or greater than 10 wt.% (based on the total weight of the flavor particle). In a particular embodiment, the flavor particle comprises a flavor in an amount of equal to or less than 40 wt.% and preferably equal to or less than 30 wt.% (based on the total weight of the flavor particle). In a particular embodiment, the flavor particle comprises the flavor in an amount of 1 to 40 wt.%, preferably 5 to 30 wt.% and more preferably 10 to 30 wt.% (based on the total weight of the flavor particle).

The flavor particle according to the present invention further comprises allulose.

By the term “allulose” it is herein understood a compound having the IUPAC name (3R,4R,5R)-1,3,4,5,6-Pentahydroxyhexan-2-one.

In a particular embodiment, the flavor particle comprises allulose in an amount of equal to or greater than 1 wt.% and preferably equal to or greater than 5 wt.% (based on the total weight of the flavor particle). In a particular embodiment, the flavor particle comprises allulose in an amount of equal to or less than 40 wt.%, and preferably equal to or less than 30 wt.% (based on the total weight of the flavor particle). In a particular embodiment, the flavor particle comprises allulose in an amount of 1 to 40 wt.%, preferably 5 to 40 wt.%, more preferably 5 to 30 wt.% (based on the total weight of the flavor particle).

Flavor particle according to the present invention further comprises a carrier.

In a particular embodiment, the carrier is practically neutral from a flavor point of view, i.e. that does not significantly alter the organoleptic properties of flavoring ingredients.

In a particular embodiment, the carrier is a solid carrier.

In a particular embodiment, the carrier is a biopolymer.

In a particular embodiment, the carrier is a food grade biopolymer.

In a particular embodiment, the carrier is a water-soluble food grade biopolymer.

In a particular embodiment, the carrier is a starch derivative, gums, fibers, polysaccharides, proteins, soluble flours or mixtures thereof.

The term “starch derivative” has the normal meaning of the term to a person skilled in the art. Starch derivatives, also known as modified starch, are prepared by enzymatically, physically or chemically treating native starch to alter its properties. Particular examples of starch derivatives comprise maltodextrin, dextrin, resistant starch, hydroxypropylated starch, phosphate starch phosphate, octenylsuccinated starch, starch aluminium octenyl succinate, acetylated distarch phosphate, acetylated distarch adipate, acetylated distarch adipate, hydroxypropyl distarch phosphate and acetylated oxidized starch. The term “gums” has the normal meaning of the term to a person skilled in the art. Gums can be derived from botanical sources, seaweeds, and bacteria fermentation. Particular examples of gums comprise gum arabic, gum tragacanth, gum karaya, gum ghatti, ocra gum, glucomannan, gellan gum, alginate, etc. The term “fibers” has the normal meaning of the term to a person skilled in the art. They cannot be digested by human body’s enzymes. Particular examples of fibers comprise inulin, fructooligosaccharides, beta glucan, arabinogalactan, glucomannan, psyllium, soluble corn fiber etc. The term “polysaccharides” has the normal meaning of the term to a person skilled in the art. Particular examples of polysaccharides comprise tamarind seed polysaccharide, soy polysaccharide, galactomannan, xyloglucan, carrageenan, pectin, curdlan, arabinan, arabinoglactan, etc.The term “proteins” has the normal meaning of the term to a person skilled in the art. Paticular examples of proteins comprise pea protein, soy protein, lentil proteins, chickpea protein, rice protein, potato protein, fava bean protein, mung bean protein, canola protein, etc. The term “soluble flour” has the normal meaning of the term to a person skilled in the art. Soluble fours are flours with chemical, physical, or enzymatical treatment to increase their solubility and functionality. Particular examples of soluble flours comprise soluble rice flour, soluble brown rice flour, koji rice, etc.

In a particular embodiment, the carrier is a modified starch, maltodextrin or mixtures thereof.

According to an embodiment, the particles does not comprise sucrose and/or glucose.

In a particular embodiment, the flavor particle comprises a carrier in an amount of equal to or greater than 20 wt.%, preferably equal to or greater than 30 wt.% and more preferably equal to or greater than 40 wt.% (based on the total weight of the flavor particle). In a particular embodiment, the flavor particle comprises a carrier in an amount of equal to or less than 98 wt.%, preferably equal to or less than 85 wt.% and more preferably equal to or less than 80 wt.% (based on the total weight of the flavor particle). In a particular embodiment, the flavor particle comprises a carrier in an amount of 20 to 98 wt.%, preferably 30 to 85 wt.% and more preferably 40 to 80 wt.% (based on the total weight of the flavor particle).

In a particular embodiment, the weight ratio of the flavor to the carrier is 1:2 to 1:9, preferably 1:2.5 to 1:8 (w/w).

In a particular embodiment, the weight ratio of the flavor to allulose is 1:1 to 1:0.01, preferably 1:0.8 to 1:0.1 (w/w).

In a particular embodiment, the weight ratio of the allulose to the carrier is 1:2 to 1:40, preferably 1:5 to 1:30 (w/w).

The flavor particle according to the present invention may further comprise an emulsifier.

By the term “emulsifier” it is herein understood as a substance that stabilizes an emulsion by increasing its kinetic stability.

In a particular embodiment, the emulsifier is a modified starch, gums, proteins, small molecule surfactant, plant extract, saponins, plant-derived proteins, protein hydrolysates, citrus fiber, sugar beet fiber or mixtures thereof.

The term “modified starch” has the normal meaning of the term to a person skilled in the art. Particular examples of modified starches comprise hydroxypropylated starch, phosphate starch phosphate, octenylsuccinated starch, starch aluminium octenyl succinate, acetylated distarch phosphate, acetylated distarch adipate, acetylated distarch adipate, hydroxypropyl distarch phosphate and acetylated oxidized starch. The term “gums” has the normal meaning of the term to a person skilled in the art. Particular examples of gums comprise gum arabic, gum karaya, gum ghatti, gum tragacanth, okra gum, etc. The term “proteins” has the normal meaning of the term to a person skilled in the art. Particular examples of proteins comprise pea protein, soy protein, lentil proteins, chickpea protein, rice protein, potato protein, fava bean protein, mung bean protein, canola protein, etc. The term “small molecule surfactant” has the normal meaning of the term to a person skilled in the art. Particular examples of small molecule surfactants comprise quillaja saponins, yucca saponins, phospholipids, lecithin, lysolecithin, diacetyltartaric and fatty acid esters of glycerol (DATEM), citric acid esters of mono and diglycerides (CITREM), etc.

In a particular embodiment, the emulsifier is modified food starch, gum arabic, Quillaja saponins, lecithin, DATEM, CITREM, citrus fiber, soluble rice flour, pea protein or mixtures thereof.

In a particular embodiment, the flavor particle comprises the emulsifier in an amount of equal to or greater than 0.5 wt.%, preferably equal to or greater than 5 wt.% and more preferably equal to or greater than 10 wt.% (based on the total weight of the flavor particle). In a particular embodiment, the flavor particle comprises the emulsifier in an amount of equal or less than 30 wt.% and preferably equal to or less 20 wt.% (based total weight of the flavor particle). In a particular embodiment, the flavor particle comprises the emulsifier in an amount of 1 to 30 wt.%, preferably 5 to 20 wt.% and more preferably 10 to 20 wt.% (based on the total weight of the flavor particle).

The flavor particle according to the present invention may further comprise a sweetener.

By the term “sweetener” it is herein understood an ingredient that imparts a sweet taste impression.

In a particular embodiment, the sweetener can be a natural sweetener or artificial sweetener.

In a particular embodiment, the sweetener is a natural or artificial sweetener except for mono- and disaccharides.

In a particular embodiment, the sweetener is a low-glycemic sweetener. A low-glycemic sweetener has a glycemic index (GI) of 55 or less, preferably of 50 or less.

In a particular embodiment, the sweetener can be stevia extracts, glycosylated derivatives of stevia extracts, glycosylated steviol glycosides (GSG), sucralose, D-tryptophan, NHDC, polyols, stevioside, Rebaudioside A, thaumatin, mogrosides, monellin, neotame, aspartame, alitame, potassium acesulfame, saccharine, monoammonium glycyrrhizinate, calcium cyclamate, sodium cyclamate, sodium saccharin, potassium saccharin, ammonium saccharin, and calcium saccharin and mixtures thereof.

In a particular embodiment, the sweetener is a natural sweetener.

By the term “natural sweeteners” it is herein understood a sweetener which is obtainable from a natural source. In contrast to an “artificial sweetener”, a “natural sweetener” can be also derived from a natural source but is not obtainable only by chemical synthesis or biotechnological processes. A “natural sweetener” can be obtained for example by extraction, enzymatic transformation, and fermentationfrom natural sources, such as plants.

In a particular embodiment, the natural sweetener can be glycosylated steviol glycosides (GSG), stevia extracts, steviol glycosides, rubusoside, rebaudioside, mogroside, Luo Han Guo extract, or mixtures thereof.

A particular embodiment, the flavor particle comprises the sweetener in an amount of equal to or greater than 1 wt.% and equal to or greater than 5 wt.% (based on the total weight of the flavor particle). In a particular embodiment, the particle comprises the sweetener in an amount of equal to or less than 30 wt.% and preferably equal to or less than 20 wt.% (based on the total weight of the flavor particle). In a particular embodiment, the flavor particle comprises the sweetener in an amount of 1 to 30 wt.% and preferably 5 to 20 wt.% (based on the total weight of the flavor particle).

In a particular embodiment, the flavor particle may further comprise water.

It is understood that the flavor particle may comprise only such amount of water so that it is still in form of a solid particle and not in the form of a liquid.

In a particular embodiment, the flavor particle according to the present invention is a stable flavor particle. By “stable flavor particle” it is herein understood that the flavor particle is stable against loss of sensory performance at room temperature in dry environment for at least 12 months.

Moreover, the present invention relates to a flavored article comprising the flavor particle as described herein-above and, optionally, a flavor base article.

The flavored article or flavored product may be a beverage or food product.

In a particular embodiment, the flavored article may be suitable for conveying flavors to beverages, fluid dairy products, condiments, baked goods, frostings, bakery fillings, candy, chewing gum and other food products.

When the food product is a particulate or powdery food, the dry particles may easily be added thereto by dry-mixing. Typical food products are selected from the group consisting of an instant soup or sauce, a breakfast cereal, a powdered milk, a baby food, a powdered drink, a powdered chocolate drink, a spread, a powdered cereal drink, a chewing gum, an effervescent tablet, a cereal bar, and a chocolate bar. The powdered foods or drinks may be intended to be consumed after reconstitution of the product with water, milk and/or a juice, or another aqueous liquid.

Beverages include, without limitation, carbonated soft drinks, including cola, lemon-lime, root beer, heavy citrus (“dew type”), fruit flavored and cream sodas; powdered soft drinks, as well as liquid concentrates such as fountain syrups and cordials; coffee and coffee- based drinks, coffee substitutes and cereal-based beverages; teas, including dry mix products as well as ready-to-drink teas (herbal and tealeaf based); fruit and vegetable juices and juice flavored beverages as well as juice drinks, nectars, concentrates, punches and “ades”; sweetened and flavored waters, both carbonated and still; sport/energy/health drinks; alcoholic beverages plus alcohol-free and other low-alcohol products including beer and malt beverages, cider, and wines (still, sparkling, fortified wines and wine coolers); other beverages processed with heating (infusions, pasteurization, ultra-high temperature, ohmic heating or commercial aseptic sterilization) and hot-filled packaging; and cold-filled products made through filtration or other preservation techniques.

Fluid dairy products include, without limitation, non-frozen, partially frozen and frozen fluid dairy products such as, for example, milks, ice creams, sorbets and yogurts. Condiments include, without limitation, ketchup, mayonnaise, salad dressing, Worcestershire sauce, fruit-flavored sauce, chocolate sauce, tomato sauce, chili sauce, and mustard.

Baked goods include, without limitation, cakes, cookies, pastries, breads, donuts and the like.

Bakery fillings include, without limitation, low or neutral pH fillings, high, medium or low solids fillings, fruit or milk based (pudding type or mousse type) fillings, hot or cold make-up fillings and non-fat to full-fat fillings.

Suitable flavor base articles may be any foodstuff base, e.g. foods or beverages. Suitable foodstuff bases, e.g. foods or beverages, can be fried or not, as well as frozen or not, low fat or not, marinated, battered, chilled, dehydrated, instant, canned, reconstituted, retorted or preserved. Typical examples of said foodstuff bases include:
a seasonings or condiment, such as a stock, a savory cube, a powder mix, a flavored oil, a sauce (e.g. a relish, barbecue sauce, a dressing, a gravy or a sweet and/or sour sauce), a salad dressing or a mayonnaise;
a meat-based product, such as a poultry, beef or pork-based product, a seafood, surimi, or a fish sausage;
a soup, such as a clear soup, a cream soup, a chicken or beef soup or a tomato or asparagus soup;
a carbohydrate-based product, such as instant noodles, rice, pasta, potatoes flakes or fried, noodles, pizza, tortillas, wraps;
a dairy or fat product, such as a spread, a cheese, or regular or low fat margarine, a butter/margarine blend, a butter, a peanut butter, a shortening, a processed or flavored cheese;
a savory product, such as a snack, a biscuit (e.g. chips or crisps) or an egg product, a potato/tortilla chip, a microwave popcorn, nuts, a bretzel, a rice cake, a rice cracker, etc;
an imitation product, such as a dairy (e.g a reformed cheese made from oils, fats and thickeners) or seafood or meat (e.g. a vegetarian meat replacer, veggie burgers) analogue; or ” a pet or animal food.

The flavor particle may be prepared by any suitable method readily selected by one of ordinary skill in the art. Non-limiting examples of methods include extrusion, spray drying, and the like.

According to an embodiment, the flavor particle is prepared by spray drying.

According to another embodiment, the flavor particle is prepared by extrusion, preferably twin-screw extrusion or hot-melt extrusion.

Moreover, the present invention relates to a process for preparing a flavor particle as described herein above, wherein the flavor particle is prepared by the steps of:
a) Mixing the flavor, allulose, the carrier, and optionally the sweetener, optionally in a twin-screw extruder,
b) optionally, homogenizing the resulting mixture in water, optionally in the presence of an emulsifier,
c) optionally, drying the resulting, optionally homogenized, mixture, preferably by spray drying.

The process according to the present invention comprises a step i) of mixing the flavor, the allulose and the carrier.

It is herein understood that the flavor, the allulose and the carrier can be mixed by any mixing means known to a skilled person.

In a particular embodiment, the allulose and the carrier are pre-mixed and then the flavor is added subsequently.

In a particular embodiment, the allulose and the carrier are dissolved in water and the flavor is added subsequently.

In a particular embodiment, in case a sweetener is added, the allulose, the carrier and the sweetener are premixed and then the flavor is added subsequently.

In a particular embodiment, in case a sweetener is added, the allulose, the carrier and the sweetener are dissolved in water and then the flavor is added subsequently.

In a particular embodiment, the allulose, the carrier and the flavor are be mixed in an extruder, in particular in a twin-screw extruder.

In a particular embodiment, the allulose, the carrier and the flavor and optionally water are mixed with a lubricant in the extruder, in particular in the twin-screw extruder.

In a particular embodiment, the resulting mixture can be extruded from the extruder, in particular from the twin-screw extruder, through a die plate, preferably comprising diameter holes in the range of 0.1 to 1 mm, preferably 0.3 to 0.9 mm, more preferable 0.7 mm to obtain extruded particles.

In a particular embodiment, the extruded particles are further sieved, preferably between 200 and 1200 µm and more preferably between 400 µm and 1000 µm.

The process according to the present invention comprises an optional step ii) of homogenizing the resulting mixture in water.

By resulting mixture, it is herein understood the resulting mixture of step i).

In a particular embodiment, homogenizing of the resulting mixture is conducted in the presence of an emulsifier.

The process according to the present invention comprising an optional step iii) of drying the resulting, optionally homogenized, mixture.

In a particular embodiment, the drying is conducted by spray drying.

Moreover, the present invention relates to a use of a particle as described herein above for stabilizing the flavor.

In other word, the present invention relates to a method of stabilizing the flavor by incorporating the flavor to a particle as described herein above.

The definitions of the flavor and the particle are the same as described herein above.

In a particular embodiment, the particle stabilizes the flavor from environmental influences, such as from oxidation by ambient air.

Moreover, the present invention relates to the use of a flavor particle as described herein above for modifying, enhancing, imparting or improve a flavor impression to a flavored article or flavor base article.

In other word, the present invention relates to a method of modifying, enhancing, imparting or improve a flavor impression of a flavored article or flavor base article by adding a flavor particle as described herein-above.

The definitions of the flavor and the particle are the same as described herein above.

### EXAMPLES

### 1) Flavor Particles Containing Allulose Via Spray Drying

A box type dryer (Ernest D. Menold Inc., Lester, PA, USA) equipped with a high-pressure homogenizer and high-pressure nozzle atomizer was used to produce spray dried orange oil flavor particles. The dryer has water evaporation capacity of 20 kg/hr. The batch size was 10 kg for all spray dried flavor particles.

First allulose and all powder ingredients were dissolved in water in a steam-jacked kettle with a Lightnin® mixer. The quantity of water was determined to obtain 50% w/w solids content. This matrix solution was mixed at 65° C. for 30 min to ensure fully hydration of materials.

Then orange oil was added and mixed for 5 min to form a pre-emulsion. The resultant coarse emulsion was passed through a two-stage high pressure Gaulin M12 homogenizer from Manton-Gaulin Company (Boston, MA, USA) at 14 MPa (1^{st} stage) and 1.4 MPa (2^{nd} stage).

Finally, the homogenized emulsion was atomized at 7 MPa with inlet and outlet air temperatures of the dryer maintained at 180-190° C. and 70-80° C., respectively.

The samples were collected for analysis of retained oil content and glass transition temperature.

### Oil Content Measurement by TD-NMR

Time-domain nuclear magnetic resonance (TD-NMR, Minispec mq20, Bruker, Billerica, USA) was used for orange oil content measurement as described in previous study (Hafner, Dardelle, Normand, & Fieber, 2011).

Instrument settings were four scan of spin-echo, 20 seconds of recycle delay, and 0.05 second of sampling window.

A calibration curve of orange oil was created using neat orange oil at five different concentrations. Measurements were conducted in duplicate and an average is reported.

### Glass Transition Temperature Measurement

Glass Transition Temperature (T_{g}) measurements were conducted on a differential scanning calorimeter Q2000 (TA Instruments, New Castle, DE, USA).

Small samples (5~10 mg) were sealed in hermetic aluminum pans (Tzero, T161003). The program consisted of the following steps: equilibrate at -20° C. for 5 minutes, ramp to 100° C. at 10° C./min, cooling to -20° C., hold isothermal at -20° C. for 5 min and ramp to 100° C. at 10° C./min.

The instrument was calibrated for the melting temperature and enthalpy of fusion of Indium (Standard Reference Material 2232, National Institute of Standards and Technology, Gaithersburg, MD).

The glass transition temperature was taken as the inflection point on the second heating ramp (rescan). All samples were measured in triplicate and the average is reported.

Table 1 shows the formulation of spray dried orange flavor containing glucose, sucrose, and allulose, respectively. Prototypes made with allulose (Examples C and D) achieved the same or better orange oil retention compared to prototypes made with glucose (Example A) or sucrose (Example B). All prototypes have high glass transition temperature far above room temperature which ensures their physical and chemical stability during storage.

TABLE 1

Spray dry feed emulsion formulation and retained oil content and glass transition temperature of spray dried powders containing glucose, sucrose, and allulose

| Composition | Examples | | | |
|---|---|---|---|---|
| | A | B | C | D |
| Orange flavor | 1.0 kg | 1.0 kg | 1.0 kg | 1.0 kg |
| Gum arabic^{a} | 0.4 kg | 0.4 kg | 0.4 kg | 0.4 kg |
| Maltodextrin 18 DE^{b} | 3.4 kg | | 3.4 kg | |
| Maltodextrin 10 DE^{b} | | 3.2 kg | | 3.2 kg |
| Glucose | 0.2 kg | | | |
| Sucrose | | 0.4 kg | | |
| Allulose (dry basis)^{c} | | | 0.2 kg | 0.4 kg |
| Water content (before spray drying) | 5.0 kg | 5.0 kg | 5.0 kg | 5.0 kg |
| Retained oil of spray dried powder | 19.0% | 19.2% | 19.3% | 19.7% |
| T_{g} (°C) of spray dried powder | 82.0 | 88.0 | 83.0 | 74.0 |

^{a}Gum arabic Instantgum™ AA, Nexira, NJ, USA.
^{b} Maltodextrin with dextrose equivalent (DE) value of 18 (known as 18 DE, Mₙ = 1,030 g mol⁻ ¹), and 10 DE (Mₙ = 1,500 g mol⁻¹). The number average molecular weight (Mₙ) of these maltodextrins was measured by size exclusion chromatography; maltodextrins were purchased from Cargill, MN, USA.
^{c}Allulose ASTRAEA®, Ingredion, NJ, USA.

Likewise, spray dried orange flavors were prepared with a blend of gum arabic and allulose (Examples I and J), a blend of gum arabic and sucrose (Examples K and L), a blend of pea protein and allulose (Examples M and N), and a blend of pea protein and sucrose (Examples O and P) at different ratios (see Table 2). These carriers are maltodextrin free. Gum arabic and pea protein serve as both emulsifier and carrier. Gum arabic and pea protein are more viscous than maltodextrin. Therefore, 40% and 30% feed solids were prepared for the feed emulsion with gum arabic and pea protein, respectively.

As shown in Table 2, all powders containing allulose showed higher retained oil content than the corresponding ones containing sucrose. Hence, allulose as a small sugar enhances oil encapsulation during spray drying compared to sucrose. The slightly lower retained oil content for powders containing pea protein compared to gum arabic is largely because of their higher viscosity and lower feed solids content. These data clearly demonstrate that both gum arabic and pea protein can be used along with allulose for flavor encapsulation via spray drying, wherein higher oil retained is achieved for allulose compared to sucrose.

TABLE 2

Spray dry feed emulsion formulation and retained oil content and glass transition temperature of spray dried powders containing sucrose and allulose

| Composition | Examples | | | | | | | |
|---|---|---|---|---|---|---|---|---|
| | I | J | K | L | M | N | O | P |
| Orange flavor | 0.8 kg | 0.8 kg | 0.8 kg | 0.8 kg | 0.6 kg | 0.6 kg | 0.6 kg | 0.6 kg |
| Gum arabic^{a} | 2.9 kg | 2.6 kg | 2.9 kg | 2.6 kg | | | | |
| Pea protein^{b} | | | | | 1.9 kg | 1.7 kg | 1.9 kg | 1.7 kg |
| Sucrose | | | 0.3 kg | 0.6 kg | | | 0.5 kg | 0.7 kg |
| Allulose^{c} (dry basis) | 0.3 kg | 0.6 kg | | | 0.5 kg | 0.7 kg | | |
| Water content (before spray drying) | 6.0 kg | 6.0 kg | 6.0 kg | 6.0 kg | 7.0 kg | 7.0 kg | 7.0 kg | 7.0 kg |
| Retained oil of spray dried powder | 19.1% | 19.3% | 17.8% | 18.6% | 18.6% | 18.8% | 17.3% | 18.0% |
| T_{g} (°C) of spray dried powder | 70.0 | 59.0 | 88 | 75 | N/A^{d} | N/A^{d} | N/A^{d} | N/A^{d} |

^{a}Gum arabic Instantgum™ AA, Nexira, NJ, USA
^{b}Pea protein PurisPea 870H, Cargill, MN, USA.
^{c}Allulose ASTRAEA, Ingredion, NJ, USA.
^{d}N/A, glass transition temperature was not determined for these samples

### 2) Flavor Particles Containing Allulose Via Twin Screw Extrusion

A BC-21 co-rotating twin-screw extruder (Clextral, Firminy France, L/D =32) was used to encapsulate single fold, cold pressed orange oil into a solid particulate form.

All sugars and powder ingredients were pre-blended and then fed into the extruder by means of a loss-in-weight feeder with a flow rate of 8.0-9.0 kg/hr.

Orange oil was injected into the extruder.

A small amount of lubricant and water were injected into the extruder to obtain extruded particles with glass transition temperature (T_{g}) of around 40° C. Temperature set points of the extruder barrels ranged from 20-100° C. The screw speed kept constant at 500 rpm. The carbohydrate melt was extruded through a die plate with 0.7 mm diameter holes.

After establishing steady-state extrusion condition, particles were cut by means of rotating cutting blades/knives and particles were sieved between 400 and 1,000 µm.

The samples were collected for analysis of retained oil content and glass transition temperature.

Table 3 shows the formulation of extruded particles containing glucose, sucrose, and allulose, respectively. Prototypes made with allulose (Examples G and H) achieved the similar orange oil retention compared to prototypes made with glucose (Example E) or sucrose (Example F). All prototypes have glass transition temperature around 40° C. which ensures their physical and chemical stability during storage at room temperature.

TABLE 3

Twin screw extrusion formulation and retained oil content and glass transition temperature of extruded particles containing glucose, sucrose, and allulose

| Composition | Examples | | | |
|---|---|---|---|---|
| | E | F | G | H |
| Orange oil | 1.2 kg | 1.2 kg | 1.2 kg | 1.2 kg |
| Modified starch^{a} | 2.8 kg | 2.8 kg | 2.8 kg | 2.8 kg |
| Maltodextrin 18 DE^{b} | 5.0 kg | | 5.0 kg | |
| Maltodextrin 5 DE^{b} | | 4.4 kg | | 4.4 kg |
| Glucose | 0.4 kg | | | |
| Sucrose | | 0.8 kg | | |
| Allulose^{C} | | | 0.4 kg | 0.8 kg |
| Water | 0.4 kg | 0.65 kg | 0.32 kg | 0.56 kg |
| Lubricant | 0.2 kg | 0.2 kg | 0.2 kg | 0.2 kg |
| Retained oil of extruded particle | 9.8% | 10.1% | 10.3% | 10.2% |
| T_{g} (°C) of extruded particle | 42.0 | 46.0 | 40.0 | 44.0 |

^{a} Modified starch Capsul®, Ingredion, NJ, USA
^{b} Maltodextrin with dextrose equivalent (DE) value of 18 (known as 18 DE, Mₙ= 1,030 g mol⁻¹) and 5 DE (Mₙ = 2,500 g mol⁻¹). The number average molecular weight (Mₙ) of these maltodextrins was measured by size exclusion chromatography. Both maltodextrins were purchased from Cargill, MN, USA
^{C}Allulose ASTRAEA®, Ingredion, NJ, USA

### 3) Conclusion

From Examples A-P, it can be concluded that allulose can be incorporated in encapsulation matrices to replace simple sugars, such as glucose, sucrose, etc.

Allulose achieved better encapsulation performance than other sugars as shown by the retained oil percentage. In this regard, it is noteworthy that in particular when comparing a substitution of sugars such as glucose and sucrose by the same amount of allulose, a better encapsulation performance as shown by the retained oil percentage is provided.

Moreover, by substituting sugars such as glucose and sucrose by allulose, the flavor particle has a lower glycemic index.

1. Flavor particle comprising
a flavor,
allulose,
a carrier
optionally, an emulsifier, and
optionally, a sweetener.

2. Flavor particle according to claim 1, wherein the flavor particle has a glass transition temperature greater than 25° C. and less than 120° C.

3. Flavor particle according to claim 1, wherein the flavor particle has an average particle size of 30 to 5000 µm.

4. Flavor particle according to claim 1, wherein the flavor particle comprises the flavor in an amount of 1 to 40 wt.% based on the total weight of the flavor particle.

5. Flavor particle according to claim 1, wherein the flavor particle comprises allulose in an amount of 1 to 40 wt.% based on the total weight of the flavor particle.

6. Flavor particle according to claim 1, wherein the flavor particle comprises the carrier in an amount of 20 to 98 wt.% based on the total weight of the flavor particle.

7. Flavor particle according to claim 1, wherein the carrier, is a starch derivative, a gum, a fiber, a fructooligosaccharide, beta-glucan, psyllium, glucomannan, arabinogalactan, a polysaccharide, a protein, a soluble flour or a mixture thereof.

8. Flavor particle according to claim 1, wherein the flavor particle comprises the emulsifier in an amount of 0.5 to 30 wt.% based on the total weight of the flavor particle.

9. Flavor particle according to claim 1, wherein the emulsifier is a modified starch, gums, proteins, small molecule surfactant, plant extract, saponins, plant-derived proteins, protein hydrolysates, citrus fiber, sugar beet fiber or mixtures thereof.

10. Flavor particle according to claim 1, wherein the flavor particle comprises the sweetener in an amount of 1 to 30 wt.% based on the total weight of the flavor particle.

11. Flavor particle according to claim 1, wherein the sweetener is a natural sweetener.

12. Flavored article comprising the flavor particle according to claim 1 and, optionally, a flavor base article.

13. Process for preparing a flavor particle according to claim 1, wherein the flavor particle is prepared by the steps of:
a) Mixing the flavor, allulose, the carrier, and optionally the sweetener, optionally in a twin screw extruder,
b) optionally, homogenizing the resulting mixture in water, optionally in the presence of an emulsifier
c) optionally, drying the resulting, optionally homogenized, mixture.

14. (canceled)

15. Method of stabilizing the flavor by incorporating the flavor in a particle according to claim 1.

16. Flavor particle according to claim 1, wherein the carrier is a food grade biopolymer.

17. Flavor particle according to claim 1, wherein the flavor particle has a glass transition temperature greater than 40° C. to less than 90° C.

18. Flavor particle according to claim 1, wherein the flavor particle has an average particle size of 50 to 1000 µm.

19. Flavor particle according to claim 1, wherein the flavor particle comprises:
the flavor in an amount of 10 to 30 wt.%,
allulose in an amount of 5 to 30 wt.%,
the carrier in an amount of 40 to 80 wt.%,
the emulsifier in an amount of 10 to 20 wt.%, and
the sweetener in an amount of 1 to 30 wt.% and preferably 5 to 20 wt.%,
each of the above based on the total weight of the flavor particle.

20. Process according to claim 13, wherein the resulting, optionally homogenized, mixture is dried by spray drying.
